(19) United States
(12) Patent Application Publication
(10) Pub. No.: US 2025/0257885 A1
(43) Pub. Date: Aug. 14, 2025

(54) A Device and Method for Oil Storage and Energy Storage

(71) Applicant: Yuming CHENG, Qingdao, Shandong (CN)

(72) Inventors: Yuming CHENG, Qingdao, Shandong (CN); Xi CHENG, Qingdao, Shandong (CN); Yingpeng CHENG, Qingdao, Shandong (CN); Yunlong ZHOU, Qingdao, Shandong (CN)

(21) Appl. No.: 18/850,013

(22) PCT Filed: Apr. 2, 2022
(86) PCT No.: PCT/CN2022/085120

§ 371 Date: Sep. 23, 2024

(51) Int. Cl. F24F 5/00; A62C 35/02; F24F 11/84

(52) U.S. Cl. CPC F24F 5/0017; A62C 35/02; F24F 5/0046; F24F 11/84; F24F 2005/0025; F24F 2005/0053; F24F 2005/0067; F24F 2203/02

(57) ABSTRACT

The present disclosure presents an oil storage and energy storage device and method. The device comprises an oil storage system, an energy collection system, an energy storage system, and a heat exchange system. The energy collection system is connected to the heat exchange system, which is in turn connected to both the oil storage system and the energy storage system. Oil input and output pipelines are interconnected within the heat exchange system. As oil from the storage system passes through the heat exchange system, it either absorbs or releases energy, resulting in heating or cooling. The heat exchange system controls the temperature change based on the type of oil and specific requirements. The temperature-adjusted oil is then directed through the oil input and output pipelines, either into storage tanks within the energy storage system or back to the oil storage system for output. The energy absorbed or released by the oil in the conversion system is transferred to a medium within the energy input and output pipelines of the conversion system. This medium is then pumped through these pipelines for user consumption, storage, or release.

### TECHNICAL FIELD

The present disclosure pertains to the fields of oil storage, heating, ventilation, and air conditioning (HVAC), water supply and drainage, and energy storage technology. Specifically, it involves a device and method for oil storage and energy storage.

### BACKGROUND TECHNOLOGY

There is an urgent need for large-scale energy storage devices in the future. However, current battery-based energy storage is costly and limited in scale, while electrochemical energy storage technology remains immature and constrained, requiring higher standards for supporting technologies and equipment. Currently, the only feasible large-scale energy storage method is pumped hydro storage, which has been in use for a long time but demands extremely stringent site selection criteria, making it difficult to match the locations of energy consumption.

Previously, our oil storage systems could only perform the function of oil storage, occupying significant space and resources while serving a single purpose. Currently, our primary demand for energy conservation and emission reduction is the need for large-scale heat storage capabilities. Building dedicated, large-scale energy storage facilities would require immense investments. Furthermore, in areas with centralized heating or cooling systems, substantial energy is required for these purposes. Due to environmental concerns, it is no longer feasible to expand large-scale fossil fuel-based heating or cooling systems. On one hand, numerous large-scale strategic oil depots have been constructed for production or strategic reserves, and more will be built in the future, potentially reaching millions of tons in capacity. These depots solely serve the purpose of oil storage, and the stored oil may remain unused for extended periods.

For clean energy sources such as solar, wind, and geothermal, the biggest challenge lies in secure energy storage. In northern regions with abundant wind and solar resources, there are numerous mature heating pipelines, but there is no effective method to integrate wind or solar energy for heating. Similarly, in southern regions with ample solar resources, many buildings have centralized cooling systems, yet there is no satisfactory way to harness solar energy for centralized cooling. The primary issue is the lack of efficient energy storage methods. Currently, lithium-battery arrays are used to store solar or wind energy, but they are expensive and cannot guarantee complete safety.

It is generally known that oil can be utilized as a carrier and medium for energy storage, but the application of oil storage tanks for energy storage is highly limited. Due to safety concerns, the storage capacity of oil tanks is strictly restricted within a certain range, failing to meet the functional requirements of strategic energy storage. In our regulations, oil depots are considered strategic locations that must be strictly protected from fire, smoke, and any external contact except for oil storage. The oil tanks must be maintained within normal temperature ranges, with strict prohibitions against heating or temperature increases. While some oil products require heating to maintain fluidity, this heating is solely for preventing solidification and enhancing flowability, without any substantial energy storage or utilization capabilities, let alone large-scale energy storage.

Water has a heat capacity of 4200 J/kg K, while molten salt's heat capacity is 1500 J/kg·K. Gasoline, diesel, and kerosene also possess significant heat capacities, reaching 2100 J/kg·K, which is half that of water but 1.4 times that of molten salt. Most oils have ignition points above 200° C., with gasoline exceeding 400° C. Their freezing points are also low, with gasoline reaching as low as −75° C. Therefore, gasoline, diesel, and kerosene not only have greater heat capacities than molten salt but also exhibit a wider temperature range of adaptability. Contrary to common belief, these oils can withstand temperatures far beyond ambient levels without easily igniting above normal temperatures or solidifying at 0° C. They maintain their properties within a broad temperature range, requiring only control to prevent evaporation.

Within this temperature range, gasoline and diesel exhibit high volumetric energy densities. For instance, heating gasoline from −50° C. to 150° C. adds an energy of 100 kWh/m³, while heating from −50° C. to 50° C. adds 50 kWh/m³. In comparison, the volumetric energy density of lead-acid batteries is 90 kWh/m³, and that of Tesla batteries is 260 kWh/m³. Heating water from 20° C. to 80° C. adds 70 kWh/m³ of energy. However, the energy released by burning one cubic meter of gasoline is 8600 kWh/m³. As a technician in the oil storage field, they undoubtedly prefer harnessing the chemical energy obtained from burning 8600 kWh/m³ of oil rather than utilizing the physical temperature changes of large volumes of oil in storage tanks. On the other hand, HVAC technicians may not intervene in oil storage operations, lacking the opportunity to consider using oil in storage tanks as a medium for energy storage. They may even resist altering design codes or interjecting into plumbing and fire protection design to utilize water in fire pools for heat and cold storage. Only by considering the perspectives of oil storage, HVAC, plumbing, and energy storage collectively can we overcome technical biases and the constraints of different fields and design codes. By leveraging the convenience of energy conversion during oil transfers, pouring, and tank swaps, we can address the technical challenges of large-scale energy storage.

China consumes 2 million tons of oil daily, with only a 40-day reserve, equivalent to 80 million tons, far behind the hundreds of days of reserve maintained by developed countries. If we had a 100-day reserve, we would need 200 million tons, a shortfall of 120 million tons, necessitating the construction of even larger oil storage systems. The average American consumes 5000 kWh of electricity annually, while the average Chinese consumes only 1000 kWh. If we had 140 million tons of oil reserved for energy storage, with each ton storing 100 kWh, and cycling this process at least 100 times annually, we would generate 1.4 trillion kWh of electricity, accounting for 20% of China's annual electricity generation, demonstrating immense energy storage potential.

On the other hand, we have abundant solar energy resources throughout the year, yet we struggle to fully store and utilize them. This is especially true with the proliferation of photovoltaic and wind power generation, leading to significant amounts of curtailed electricity. Furthermore, our heat pump systems are underutilized, and there is ample industrial waste heat and off-peak electricity that require more comprehensive utilization.

Therefore, due to the severe shortage of energy storage resources in existing technologies, strategic and industrial oil storage depots, solar energy, heat pumps, industrial waste heat, off-peak electricity, and curtailed wind and solar power are all underutilized, leading to significant waste of energy and resources.

### Invention Content

To address the deficiencies in existing technologies, the present disclosure aims to provide a device and method for leveraging existing oil storage resources to achieve large-scale strategic energy storage.

The technical solution adopted in the present disclosure is as follows:

A device and method for oil storage and energy storage, comprising an oil storage system, an energy collection system, an energy storage system, and a heat exchange system.

The oil storage system is used for storing oil and comprises an oil storage tank group, oil materials, oil inlets and outlets, oil input and output pipelines, and an oil pump room.

The energy collection system is used for collecting heat and cold, including heat collection equipment, cold collection equipment, energy input and output pipelines, and the medium in the pipelines. The forms of collecting heat and cold encompass one or more of the following: solar photovoltaic energy collection, wind and photovoltaic curtailment energy collection, industrial waste heat collection, peak-valley power energy collection, various heat pump energy collection, and solar thermal energy collection.

The energy storage system includes either existing oil storage tank groups that have undergone insulation and heat insulation modifications along with the oil within the tanks, or specially designed oil storage tank groups with insulation and heat insulation, along with the oil within the tanks, and oil input and output pipelines.

The heat exchange system comprises heat exchangers, heat pumps, circulating pumps, valves, oil input and output pipelines, energy input and output pipelines, and the medium in the pipelines.

The heat collection and cold collection equipment are connected to the heat exchange system, transmitting the collected energy to the heat exchange system.

The oil input and output pipelines of the oil pump room and the energy storage system are connected to the heat exchange system, with the oil input and output pipelines interconnected within the heat exchange system.

Oil from the storage tanks or input by the oil pump room is driven by pumps through the heat exchange system, where it absorbs or releases energy. The oil, upon absorbing or releasing energy, is heated or cooled. The heat exchange system controls the heating or cooling temperature of the oil based on its type and requirements. The oil that has absorbed or released energy is then transported through the input and output pipelines to be stored in the storage tanks of the energy storage system or output to the oil pump room.

The energy absorbed or released by the oil in the heat exchange system heats or cools the medium in the energy input and output pipelines. This energy is then driven by pumps through the energy pipelines to be utilized by users or stored or released in other media.

Furthermore, multiple heat exchangers can be installed in the heat exchange system. These heat exchangers are connected in parallel to the oil input and output pipelines, with corresponding valve switches allowing for multiple heat exchanges, the selection of a specific heat exchanger, or bypassing the heat exchange process altogether, allowing oil to flow directly through the input and output pipelines. Heat exchangers and heat pumps can be used in series, with multiple heat pumps optionally installed to enhance heat exchange efficiency.

Additionally, the oil input and output pipelines of the oil storage system penetrate deep into the oil tanks, with three-way valves installed at appropriate positions at the bottom, middle, and top of the pipelines to facilitate oil input and output at different elevations within the tanks.

Moreover, the energy storage system may also include an oil-water control system in addition to the existing insulated oil storage tanks and their oil contents. This system comprises an oil-water separator, a water inlet, and a water outlet, allowing water to be injected into the oil storage tanks through the water inlet and excess water to be drained after separation by the oil-water separator. When the tanks are empty or in need, water or other emergency media can be injected for energy storage.

Furthermore, the oil storage tank group of the energy storage system comprises several high-temperature tanks, normal-temperature tanks, and low-temperature tanks, which are connected in parallel to the oil input and output pipelines. Valves are installed on the input and output pipelines between the tanks, allowing for the control of valve switches to direct oil of different temperatures into specific tanks, forming a temperature gradient, or to output oil from specific tanks to the oil pump room, thereby maximizing energy storage capacity and input/output efficiency.

Additionally, the oil storage tanks can be replaced with insulated firewater storage tanks or reservoirs of buildings, with the oil pump room transformed into a fire pump room and the oil input and output pipelines converted to water input and output pipelines. In emergencies, the input water pipelines can also be used as output pipelines to increase water output. Furthermore, the building's hot water system or ice storage system can be connected to the heat exchange system, enhancing energy storage capacity and equipment utilization efficiency.

Furthermore, the firefighting water storage tank group or reservoir group is an underground flood storage reservoir that has been thermally insulated. It can store energy in a timely manner, store floodwater for emergency use, pump out floodwater or water for irrigation at any time, and store and/or supply energy.

Furthermore, the underground floodwater storage reservoir can be an insulated artificial lake or reservoir, with insulation achieved by constructing an openable structure on the water surface and applying insulation thereafter. Solar energy collection equipment or other utilization devices can also be installed on the water surface structure.

This application collects solar energy, wind and photovoltaic curtailment energy, industrial waste heat, etc., through the energy collection system and stores this energy in existing modified oil storage tanks or newly designed insulated oil storage tanks. Long-term idle oil within the tanks serves as the carrier and medium for energy storage. When needed, the heat or cold stored in the oil storage tanks is extracted by the heat exchange and heat supply system for heating or cooling, eliminating the need for large-scale fossil fuel-based heating and cooling systems in centralized heating or cooling areas. This approach provides additional heat and cold energy to these areas or stores large amounts of energy for power supply or further electricity generation, thus conserving energy consumption, fully utilizing existing oil storage resources, heat and cold sources, and heating and cooling equipment resources. It enhances equipment utilization, yields significant economic benefits, and facilitates the sustainable centralized heating and cooling of clean energy, achieving remarkable results in promoting the development of the carbon emission trading market.

The beneficial effects of this invention are: it leverages existing oil storage resources for large-scale strategic energy storage, simultaneously addressing the technical challenges of large-scale, planned energy storage and release using existing equipment. This approach is cost-effective, has a low technical threshold, and is easily adaptable to various locations.

### DESCRIPTION OF THE FIGURES

To more clearly illustrate the technical solutions of the specific embodiments of the present disclosure or the prior art, the following is a brief introduction to the figures required for the description of the specific embodiments or the prior art. In all figures, similar elements or parts are generally identified by similar reference numerals. Please note that the elements or parts in the figures are not necessarily drawn to scale.

FIG. 1 depicts a system structure diagram of a device and method for oil storage and energy storage according to an embodiment of the present application.

FIG. 2 illustrates the heat exchange system structure of a device for oil storage and energy storage provided in an embodiment of the present application.

FIG. 3 shows the system structure diagram of an oil storage tank group for the device for oil storage and energy storage provided in an embodiment of the present application.

FIG. 4 presents a system structure diagram of a water storage and energy storage device utilizing the firefighting water tank group and firefighting water pond in a building, as provided in an embodiment of the present application.

FIG. 5 displays a system structure diagram of an energy storage device utilizing an underground flood storage reservoir, according to an embodiment of the present application.

FIG. 6 depicts a system structure diagram of an energy storage device utilizing a water reservoir, as provided in an embodiment of the present application.

It should be noted that the devices, systems, functions, and methods described in this disclosure are not merely conventional adaptive applications of prior art.

The following detailed description of the embodiments of the technical solutions will be provided in conjunction with the accompanying figures. These embodiments are merely used to illustrate the technical solutions more clearly and are therefore exemplary only, and should not be construed as limiting the scope of protection of this disclosure.

Please note that unless otherwise specified, the technical or scientific terms used in this application should be understood in their ordinary meanings by those skilled in the art to which this disclosure pertains.

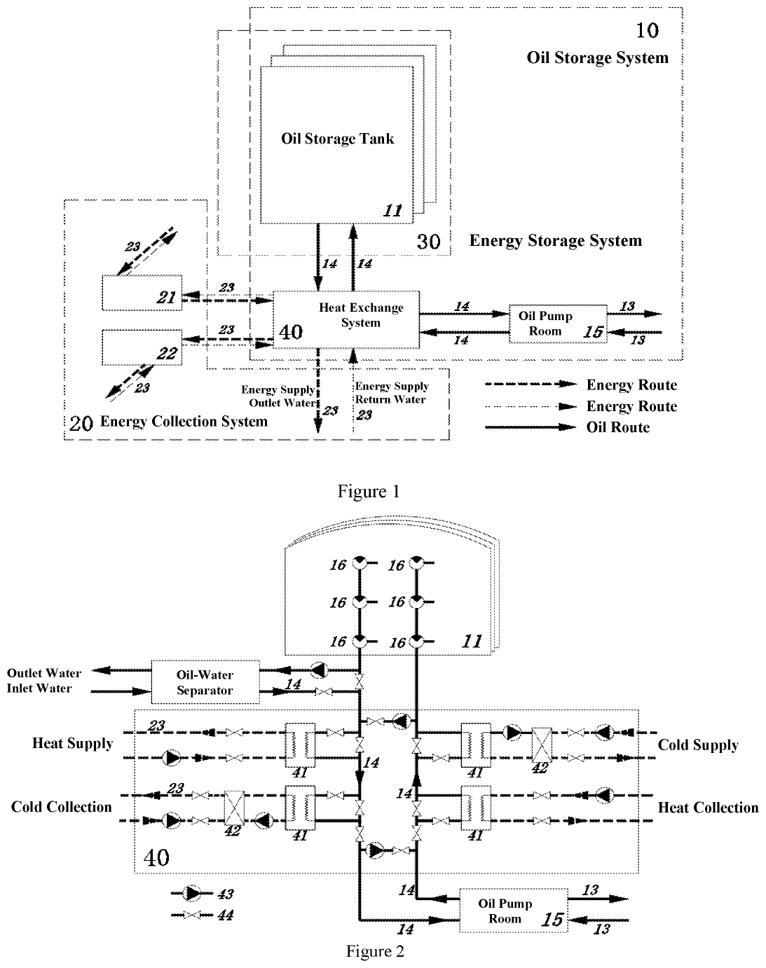

Referring to FIGS. 1 through 6, this application discloses a device and method for oil storage and energy storage, which comprises an oil storage system, a heat collection system, an energy storage system, and a heat exchange system.

Specifically, as shown in FIG. 1, the device and method for oil storage and energy storage include an oil storage system (10), an energy collection system (20), an energy storage system (30), and a heat exchange system (40).

The oil storage system (10) is used for storing oil and comprises an oil storage tank group (11), oil (12), oil inlet/outlet (13), oil input/output pipelines (14), and an oil pump room (15).

The energy collection system (20) is used for collecting heat and cold and includes heat collection equipment (21), cold collection equipment (22), energy input/output pipelines (23), and medium in pipelines (24). Forms of heat and cold collection include one or more of solar photovoltaic energy collection, abandoned wind and photovoltaic energy collection, industrial waste heat collection, peak-to-valley electricity energy collection, various heat pump energy collection, and solar thermal energy collection.

The energy storage system (30) comprises existing oil storage tank groups (11) with insulation and heat insulation modifications (31) and the oil (12) in the tanks, or specially designed oil storage tank groups (11) with insulation and heat insulation and the oil (12) in the tanks, as well as oil input/output pipelines (14).

The heat exchange system (40) comprises a heat exchanger (41), a heat pump (42), a circulating pump (43), valves (44), oil input/output pipelines (14), energy input/output pipelines (23), and medium in pipelines (24).

The heat collection equipment (21) and cold collection equipment (22) are connected to the heat exchange system (30) to input the collected energy to the heat exchange system (40).

The oil input/output pipelines (14) from the oil pump room (15) and the energy storage system (30) are connected to the heat exchange system (40), with the oil input/output pipelines (14) interconnected within the heat exchange system (40).

The oil (12) in the oil storage tanks (11) or input from the oil pump room (15) is driven by a pump through the heat exchange system (40), where it absorbs or releases energy. The oil (12) that absorbs or releases energy is heated or cooled, and the heat exchange system (40) controls the heating or cooling temperature of the oil based on its type and requirements. The oil (12) that has absorbed or released energy is then transported through the oil input/output pipelines (14) to be stored in the oil storage tanks (11) of the energy storage system (30) or output to the inlet/outlet (13) of the oil pump room (15).

The energy absorbed or released by the oil in the heat exchange system (40) heats or cools the medium (24) in the energy input/output pipeline (23). This energy, driven by pumps through the energy input/output pipeline (23), is then output for user consumption or transferred to other media for storage or release.

As shown in FIG. 2, multiple heat exchangers (41) can be installed within the heat exchange system (40). These heat exchangers (41) are connected in parallel to the oil input/output pipeline (14), allowing for the selective control of valves to enable multiple heat exchanges, a specific heat exchanger, or no heat exchange at all, where oil flows directly through the oil input/output pipeline (14). Furthermore, the heat exchangers (41) can be used in series with heat pumps (42), and multiple heat pumps (42) can be arranged to enhance heat exchange efficiency.

The oil input/output pipeline (14) of the oil storage system (10) extends deep into the oil tank (11), with three-way valves (16) strategically placed at the bottom, middle, and top of the pipeline to facilitate oil input and output at various levels within the tank.

The energy storage system (30) comprises insulated (31) oil tanks (11) and the oil contained within them (12). It may also incorporate an oil-water control system, including an oil-water separator, water inlet, and water outlet. Water can be injected into the oil tanks through the water inlet, and any water inside can be drained after separation by the oil-water separator. This allows for water or other emergency media to be injected for energy storage when the tanks are empty or required.

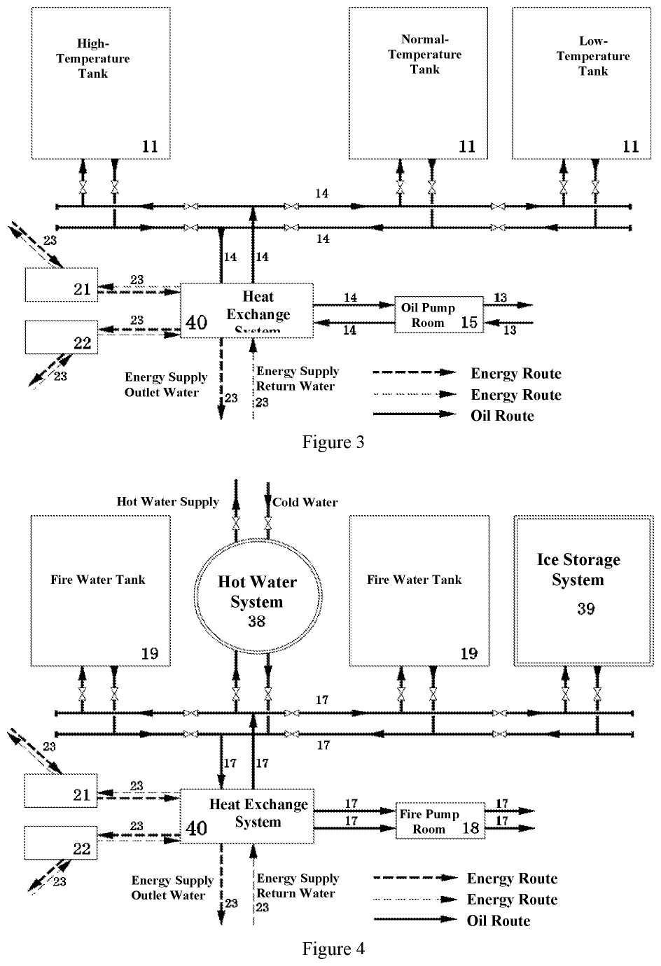

As depicted in FIG. 3, the oil tank (11) array in the energy storage system (30) comprises high-temperature oil tanks (11), normal-temperature oil tanks (11), and low-temperature oil tanks (11), all connected in parallel to the oil input/output pipeline (14). Valves (44) are installed on the pipelines between tanks, enabling the controlled transfer of oil (12) at different temperatures to specific tanks (11), creating a temperature gradient. Alternatively, oil (12) from a designated tank (11) can be directed to the oil pump room (15), maximizing energy storage capacity and oil transfer efficiency.

The energy storage system (30) leverages the energy collection system (20) for timely heat or cold collection, particularly utilizing various heat pump (42) configurations to transport and separate heat between tanks (11). The heat exchange system (40) provides cooling or heating as needed, while the interconnected oil tanks simultaneously fulfill oil storage and energy storage functions. Multiple oil tank (11) arrays can be installed in the oil depot.

Temperature ranges can be set as follows: high-temperature tanks at 35° C. to 150° C., normal-temperature tanks at 15° C. to 35° C., and low-temperature tanks at −50° C. to 15° C. Multiple high- and low-temperature tanks can be arranged to form a temperature gradient, facilitating heat transfer and conversion using heat pumps.

The energy collection system (20) connects to the heat exchange system (40), which in turn links to the energy storage system (30), facilitating heat collection and storage. High-temperature oil tanks (11) are connected to the heat exchange system (40) for heat supply or underground energy storage. Additionally, these tanks (11) are interconnected with other tanks via oil pipelines (14), enabling heat-exchanged oil (12) from high-temperature tanks to be transferred to normal-temperature tanks for timely adjustment and use. Near the end of summer, heat can be stored in tanks or underground using the energy collection system (20) or heat pumps, ready for utilization by the heat exchange system (40) during winter.

Similarly, for cold collection and storage, the energy collection system (20) connects to the heat exchange system (40), which links to the energy storage system (30). Low-temperature oil tanks (11) are connected to the heat exchange system (40) for cold supply or underground cold storage. Oil from low-temperature tanks can be transferred to normal-temperature tanks via interconnecting pipelines for timely adjustment and use. As winter draws to a close, heat pumps can be employed to store cold within tanks or underground, ready for deployment by the heat exchange system (40) during summer.

The high-temperature oil storage tank (11) and low-temperature oil storage tank (11) can be adjusted and transformed as needed in a timely manner. For instance, after the heat stored in the high-temperature oil storage tank (11) is utilized during winter, it can be converted into a low-temperature oil storage tank (11) for cold storage. Similarly, once the cold storage in the low-temperature oil storage tank (11) is used up during summer, it can then function as a high-temperature oil storage tank (11) for heat storage. Oil storage tanks (11) can also be adjusted to high-temperature storage tanks (11), or the oil storage tanks (11) can be adjusted in their temperature gradient to suit either high- or low-temperature requirements, or utilize heat pumps to convert low-grade heat or cold into high-grade heat or cold, thereby fulfilling the objectives of oil and energy storage.

Technical personnel in this field can combine and integrate various embodiments or examples described in this specification, as well as their respective features. For example, components of solar heating systems and heat exchange heating systems can be unified and used collectively or mutually, with control valves and sensors networked for intelligent and timely utilization.

As depicted in FIG. 4, the oil storage tank (11) comprises a group of fire water tanks (19) for buildings that have undergone thermal insulation treatment. The oil pump room (15) is converted into a fire pump room (18), while the oil input/output pipeline (14) is replaced with a water input/output pipeline (17). In case of emergency, the water input pipeline (17) can also function as a water output pipeline (17) to increase water output. Additionally, the building's hot water system (38) or ice storage system (39) can be connected to the heat exchange system (40), enhancing energy storage capacity and equipment efficiency.

The oil storage tanks serve as a group of fire water tanks (19) for buildings. The original single fire water pool can be divided into several fire water tanks (19) for thermal insulation and energy-saving retrofitting, thereby enabling energy storage. These tanks are connected in parallel using pipelines, similar to an oil storage tank group. The fire water tanks are further categorized into high-temperature, normal-temperature, and low-temperature tanks. During winter and spring, they store cold energy for air conditioning in summer; in summer and autumn, they store heat for heating in winter. This flexible approach ensures the timely utilization of various favorable resources for cold and heat storage, while also providing hot water throughout the year, thereby enhancing equipment efficiency.

For instance, a 100-ton fire water pool can be redesigned into twelve 10-ton water storage tanks, categorized as high-temperature, normal-temperature, and low-temperature tanks and interconnected. In case of emergency, water can be dispatched promptly for firefighting purposes.

The temperature range for high-temperature tanks can be set between 35° C. and 75° C., normal-temperature tanks between 15° C. and 35° C., and low-temperature tanks between 0° C. and 15° C., with adjustments made according to actual needs. Multiple high-temperature and low-temperature tanks can be installed to form a temperature gradient, facilitating heat transfer and exchange using heat pumps or interfacing with hot water and ice storage systems. In this example, during summer, ten tanks are used for cold storage, one for normal temperature, and one for high temperature. In winter, ten tanks are used for heat storage, one for normal temperature, and one for low temperature. Ensuring the availability of firewater, this system also allows for the utilization of peak-valley electricity for energy storage and conversion.

As illustrated in FIG. 5, the group of fire water tanks (19) or an underground flood storage reservoir (101) that has undergone thermal insulation treatment can store energy as needed, providing emergency flood storage and facilitating pumping for drainage or irrigation while simultaneously storing and supplying energy.

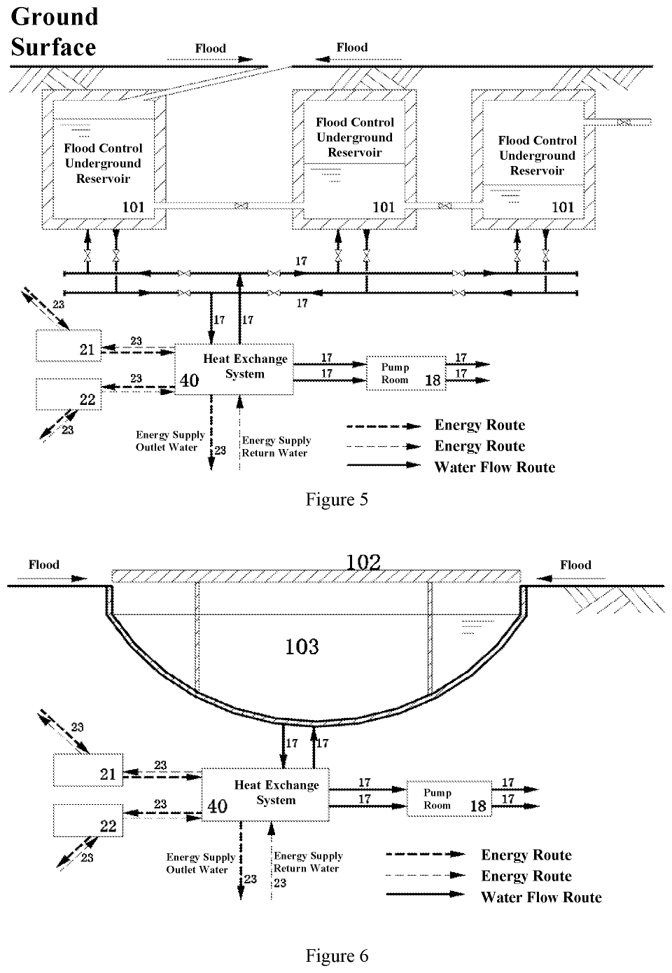

As shown in FIG. 6, the underground flood storage reservoir is an artificially constructed lake or reservoir (102) that has undergone thermal insulation treatment. An openable structure (103) is installed on the water surface, which is then subjected to thermal insulation treatment. The water surface structure (103) can also accommodate solar energy collection equipment (21) or other applications.

Fire water tanks or pools can be underground flood storage reservoirs or sewage reservoirs that have undergone thermal insulation retrofitting, or they can be artificial lakes, ponds, or reservoirs. Essentially, any above- or underground water bodies available in urban areas can be utilized. A partially openable structure is installed on the water surface, while the surrounding roof of the energy storage body undergoes energy-saving thermal insulation treatment to minimize heat loss. The structural surface can accommodate solar facilities or serve as a venue for landscaping, beautification, or the construction of greenhouses or glasshouses for planting. During winter and spring, cold energy is stored for air conditioning in summer; in summer and autumn, heat is stored for heating in winter. Energy storage can be performed at any time, and during flood seasons, the system can also function as a flood storage and drought relief measure. Furthermore, the stored water and heat enable year-round planting.

In this application, unless otherwise expressly specified or limited, terms such as “connected”, “interconnected”, “fixed” and their derivatives should be broadly interpreted. For instance, they can refer to a fixed connection, a detachable connection, or an integral formation; they can represent an electrical connection; they can signify a direct connection or an indirect connection through intermediary media; and they can describe an internal communication between two components or an interactive relationship between two components. For those skilled in the art, the specific meanings of these terms within the context of the present disclosure can be understood based on specific circumstances.

The specification of the present disclosure provides numerous specific details. However, it is acknowledged that embodiments of the invention can be practiced without these specific details. In some instances, well-known methods, systems, and technologies are not shown in detail to avoid obscuring the understanding of this specification.

Lastly, it should be noted that the above embodiments are merely illustrative of the technical solutions of the present disclosure and are not intended to limit them. Although the invention has been described in detail with reference to the preceding embodiments, those skilled in the art should appreciate that modifications can be made to the technical solutions described in these embodiments, or partial or all of the technical features can be replaced with equivalents. Such modifications or replacements do not detract from the essence of the corresponding technical solutions, which should still be encompassed within the scope of the claims and the specification of the present disclosure.

1. A device and method for oil storage and energy storage, characterized by including an oil storage system, an energy collection system, an energy storage system, and a heat exchange system;
the oil storage system is used for storing oil and comprises an oil storage tank group, oil materials, oil inlets and outlets, oil input and output pipelines, and an oil pump room;
the energy collection system is used for collecting heat and cold, including heat collection equipment, cold collection equipment, energy input and output pipelines, and the medium in the pipelines, the forms of collecting heat and cold encompass one or more of the following: solar photovoltaic energy collection, wind and photovoltaic curtailment energy collection, industrial waste heat collection, peak-valley power energy collection, various heat pump energy collection, and solar thermal energy collection;
the energy storage system includes either the oil storage tank groups that have undergone insulation and heat insulation modifications along with the oil within the tanks, or specially designed oil storage tank groups with insulation and heat insulation, along with the oil within the tanks, and oil input and output pipelines;
the heat exchange system comprises heat exchangers, heat pumps, circulating pumps, valves, oil input and output pipelines, energy input and output pipelines, and the medium in the pipelines;
the heat collection and cold collection equipment are connected to the heat exchange system, transmitting the collected energy to the heat exchange system;
the oil input and output pipelines of the oil pump room and the energy storage system are connected to the heat exchange system, with the oil input and output pipelines interconnected within the heat exchange system;
oil from the storage tanks or input by the oil pump room is driven by pumps through the heat exchange system, where it absorbs or releases energy. the oil, upon absorbing or releasing energy, is heated or cooled. the heat exchange system controls the heating or cooling temperature of the oil based on its type and requirements. the oil that has absorbed or released energy is then transported through the input and output pipelines to be stored in the storage tanks of the energy storage system or output to the oil pump room;
the energy absorbed or released by the oil in the heat exchange system heats or cools the medium in the energy input and output pipelines. this energy is then driven by pumps through the energy input and output pipelines to be utilized by users or stored or released in other media.

2. According to claim 1, the oil storage and energy storage device is characterized as follows: Multiple heat exchangers can be installed in the heat exchange system. These heat exchangers are connected in parallel to the oil input and output pipelines, with corresponding valve switches allowing for multiple heat exchanges, the selection of a specific heat exchanger, or bypassing the heat exchange process altogether, allowing oil to flow directly through the oil input and output pipelines. Heat exchangers and heat pumps can be used in series, with multiple heat pumps optionally installed to enhance heat exchange efficiency.

3. Claim 1 further specifies that the oil input and output pipelines of the oil storage system penetrate deep into the oil tanks, with three-way valves installed at appropriate positions at the bottom, middle, and top of the pipelines to facilitate oil input and output at different elevations within the tanks.

4. According to claim 1, the oil storage and energy storage device is characterized as follows: The energy storage system comprises existing oil storage tanks that have undergone insulation modifications, along with the oil contained within. These tanks can be filled with water or other emergency media for energy storage when empty or required.

5. According to claim 1, the oil storage tank group of the energy storage system comprises several high-temperature tanks, normal-temperature tanks, and low-temperature tanks, which are connected in parallel to the oil input and output pipelines. Valves are installed on the input and output pipelines between the tanks, allowing for the control of valve switches to direct oil of different temperatures into specific tanks, forming a temperature gradient, or to output oil from specific tanks to the oil pump room, thereby maximizing energy storage capacity and input/output efficiency.

6. According to claim 5, the oil storage and energy storage device and method are characterized as follows: The oil storage tanks can be replaced with insulated firewater storage tanks or building reservoirs. The oil pump room can be transformed into a fire pump room, and the oil input and output pipelines can be converted to water input and output pipelines. In emergencies, the input water pipelines can also be used as output pipelines to increase water output. Furthermore, the building's hot water system or ice storage system can be connected to the heat exchange system, enhancing energy storage capacity and equipment utilization efficiency.

7. According to claim 6, the energy storage device and method using the firefighting water storage tank group or reservoir group are characterized as follows: The firefighting water storage tank group or reservoir group is an underground flood storage reservoir that has undergone thermal insulation treatment. This reservoir can store energy in a timely manner, store floodwater for emergency use, pump out floodwater or water for irrigation at any time, and store and/or supply energy.

8. According to claim 7, the energy storage and flood storage device using the underground floodwater storage reservoir is characterized as follows: The underground floodwater storage reservoir can be an insulated artificial lake or reservoir, with insulation achieved by constructing an openable structure on the water surface and applying insulation thereafter. Solar energy collection equipment or other utilization devices can also be installed on the water surface structure.
